(19) United States
(12) Patent Application Publication
(10) Pub. No.: US 2005/0155986 A1
(43) Pub. Date: Jul. 21, 2005

(54) Reciprocating pump type spout unit

(75) Inventors: Masumi Mizukawa, Tokyo (JP); Yasuo Oshima, Tokyo (JP); Takashi Udagawa, Tokyo (JP); Hiroshi Kanno, Tokyo (JP)

Correspondence Address: VENABLE LLP, P.O. BOX 34385, WASHINGTON, DC, 20045-9998, US

(73) Assignee: Mitani Valve Co., Tokyo (JP)

(21) Appl. No.: 10/517,069

(22) PCT Filed: May 30, 2003
(86) PCT No.: PCT/JP03/06823

(30) Foreign Application Priority Data
Jun. 7, 2002 (JP) 2002-166674

(51) Int. Cl. B67D 1/08

(52) U.S. Cl. 222/148; 222/402.1; 222/571

(57) ABSTRACT

A container used in an aerosol type spout unit is made usable as a container used in a reciprocating pump type spout unit. A reciprocating pump (30) is mounted on the mouth of a container (20). And an injection button (38) is depressed to push in the piston (35) of the reciprocating pump to increase the pressure in a pressure chamber (b), and the piston is pushed down with respect to a stem (37) to let the contents of the pressure chamber into the injection button through a spout passage (37a) and deliver them through a spout port (39a), while the operator removes his hand from the injection button, thus canceling the pushing-in of the pistion, and releasing the pressure in the pressure chamber to lower the pressure in the pressure chamber, the piston being pushed up to open an inlet valve (36), sucking up the contents of the container into the pressure chamber. In such reciprocating pump type spout unit, the reciprocating pump is attached to an adaptor (22) as by screws, and the peripheral edge of the adaptor is attached to the curl portion (21) of the mouth of the container as by fitting.

### TECHNICAL FIELD

The present invention relates to a reciprocating pump type spout unit in which a reciprocating pump is mounted on the mouth of a container, a piston of the reciprocating pump is pushed in by the external operation to increase the pressure in a pressure chamber, whereby an outlet valve of the pressure chamber is opened to blow out the content in the pressure chamber to the exterior, and canceling the pushing-in of the piston to lower the pressure in the pressure chamber, and an inlet valve of the pressure chamber is opened so that the content in the container is sucked up into the pressure chamber.

### BACKGROUND ART

Conventional spout units for a makeup can be divided into those of the reciprocating pump type illustrated in FIG. 3 and those of the aerosol type illustrated in FIG. 4.

In the spout unit of the reciprocating pump type illustrated, for example, in FIG. 3, a threaded cap 2 is placed and screwed onto a mouth 1 of a bottle-like container A, and a reciprocating pump B is mounted on the container A.

To use the spout unit, a spout button 3 is depressed by hand to push in a piston 4 integral with a stem of the reciprocating pump B to increase the pressure in a pressure chamber a, whereby an outlet valve 5 of the pressure chamber a is opened permitting the content in the pressure chamber a to be introduced into a blow-out passage 4b in the piston 4 through a communication hole 4a so as to be blown out to the exterior from a spout port 6a of a nozzle member 6 attached to the spout button 3.

After the use, the operator removes the hand from the spout button 3 to cancel the pusing-in of the piston 4, whereby the piston 4 is pushed up being urged by a spring 7. Therefore, the pressure decreases in the pressure chamber a, the outlet valve 5 is closed, and a ball-like inlet valve 8 of the pressure chamber a is opened to suck up the content in the container A into the pressure chamber a.

In the aerosol type spout unit, on the other hand, the peripheral edge of a mountain cap 12 is wrap-fitted to a mouth edge 11 of the mouth of a can-like container C as illustrated, for example, in FIG. 4, and a valve unit D is attached to the mouth of the container C via the mountain cap 12.

To use the spout unit, a spout button that is not shown is depressed by hand to push in a stem 13 in the valve unit D such that a stem rubber 14 is deformed to open a communication hole 13a of the stem 13, permitting the content in the container C to be introduced into a blow-out passage 13b of the stem 13 from the communication hole 13a due to the pressure of a spout agent contained in the container C together with the content, and the content is blown out from a spout port of a nozzle member attached to the spout button that is not shown.

After the use, the operator removes the hand from the spout button to cancel the pushing-in of the stem 13. Therefore, the stem 13 is pushed up being urged by a spring 15, the stem rubber 14 liberated from the deformed state, and the communication hole 13a is closed to discontinue the blow out from the spout port.

In the conventional reciprocating pump type spout unit, the container A is made of a plastic material to lower the cost, and the reciprocating pump B is mounted on the container A by being screwed thereon to facilitate the removal of the reciprocating pump and the refilling of the content in the container.

In the aerosol type spout unit, on the other hand, the spout agent is contained in the container C together with the content. Therefore, the container C is made of a metal such as aluminum or a tin plate to withstand a high internal pressure, and the peripheral edge of the mountain cap 12 is wrap-fitted to the mouth edge 11 of the mouth of the container C so that the mountain cap cannot be easily opened.

Therefore, the reciprocating pump type spout unit and the aerosol type spout unit must use containers of different kinds causing an increase in the number of parts, in the management of parts and in the cost.

It is therefore a first object of the present invention to enable the container used for the aerosol type spout unit to be also used for the reciprocating pump type spout unit.

A second object of the present invention is to facilitate the mounting of the reciprocating pump enabling the content to be easily refilled in the container.

A third object of the present invention is to provide a reciprocating pump type spout unit having a taste different from the existing plastic containers.

A fourth object of the invention is to simplify the spouting operation.

### DISCLOSURE OF THE INVENTION

The present invention is concerned with a reciprocating pump type spout unit in which a reciprocating pump is mounted on the mouth of a container, a piston of the reciprocating pump is pushed in to increase the pressure in a pressure chamber to blow out the content in the pressure chamber, and canceling the pushing-in of the the piston to lower the pressure in the pressure chamber, and an inlet valve is opened so that the content in the container is sucked up into the pressure chamber, wherein the reciprocating pump is mounted on an adaptor, and the peripheral edge of the adaptor is mounted on the mouth of the container by being fitted thereto. The reciprocating pump is not directly mounted on the container but is mounted on the container via the adaptor. By using the adaptor that meets the shape of the mouth of the container as described above, the container used for the aerosol type spout unit can be used for the reciprocating pump type spout unit, too. Though the aerosol type spout units have, in recent years, been used in decreased numbers from the environmental point of view, the present invention makes it possible to effectively utilize the containers used for the aerosol type spout units.

In the reciprocating pump type spout unit of the invention described above, it is desired that the reciprocating pump is mounted on the adaptor by being screwed thereon. This makes it relatively easy to mount or remove the reciprocating pump on or from the adaptor and to facilitate the refilling of the content in the container.

In the reciprocating pump type spout unit of the invention described above, it is desired that the container is made of a metal. It is therefore made possible to provide a reciprocating pump type spout unit having a taste different from the conventional plastic containers.

In the reciprocating pump type spout unit of the invention described above, a spout button is depressed to move a stem, the piston is pushed in to blow out the content in the pressure chamber from the spout port of the spout button through the stem and the stem is returned back when the depressing of the spout button is canceled, and canceling the pushing-in of the piston so that the content in the container is sucked up into the pressure chamber. This makes the blow-out operation simple.

### BRIEF DESCRIPTION OF THE DRAWINGS

FIG. 1 is a side view illustrating the appearance of a reciprocating pump type spouting unit of the present invention which is in a state of not being used, and wherein a cap is illustrated in cross section;

FIG. 2 is a vertical sectional view thereof;

FIG. 3 is a vertical sectional view illustrating a portion of a conventional reciprocating pump type spout unit; and

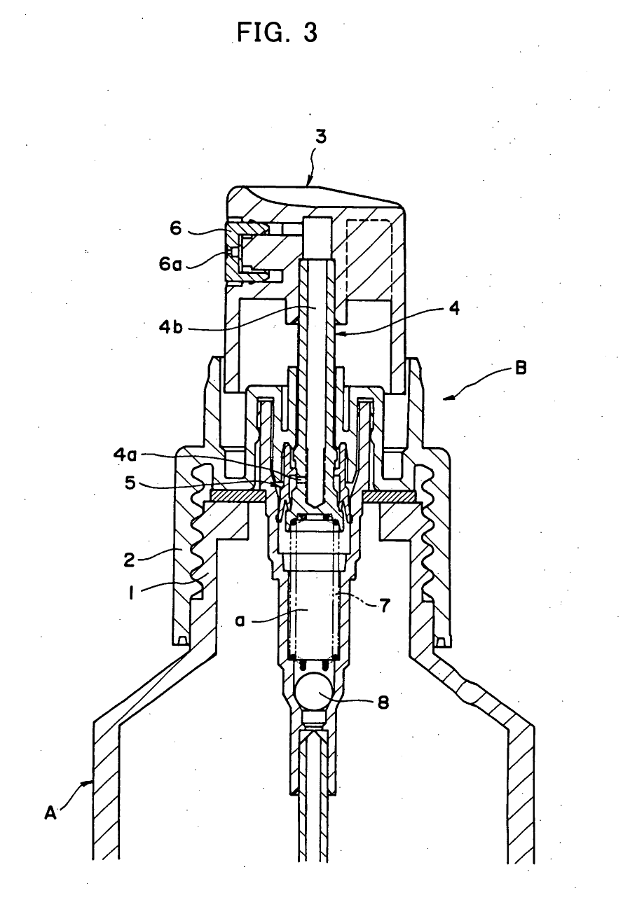

FIG. 4 is a vertical sectional view illustrating a portion of a conventional aerosol type spout unit.

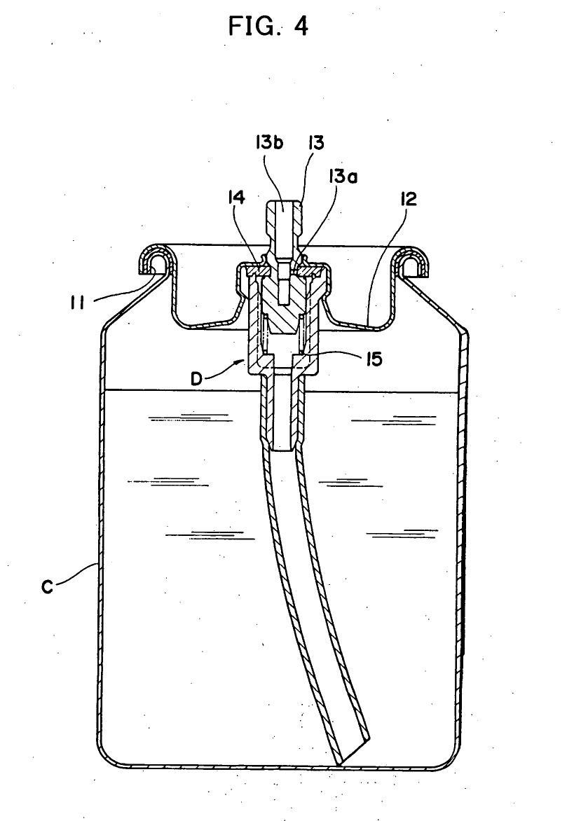

### BEST MODE FOR CARRYING OUT THE INVENTION

An embodiment of the invention will now be described with reference to the drawings.

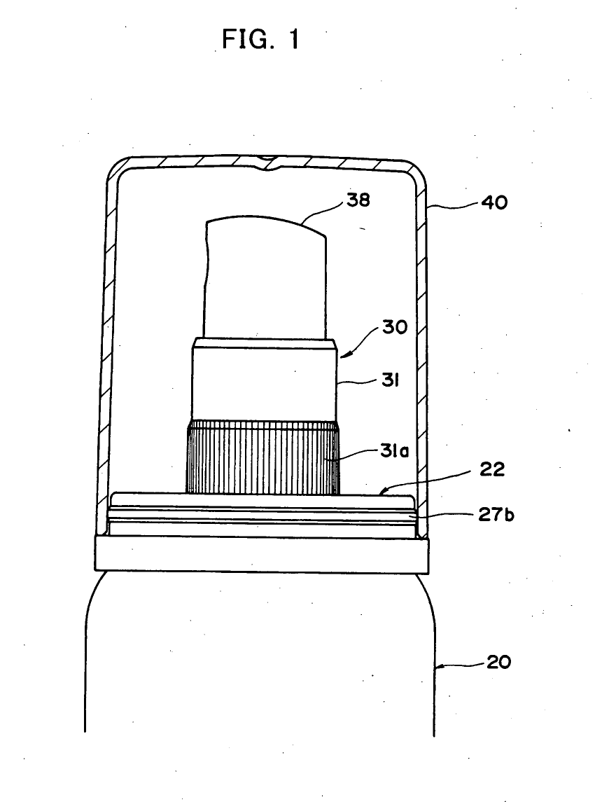

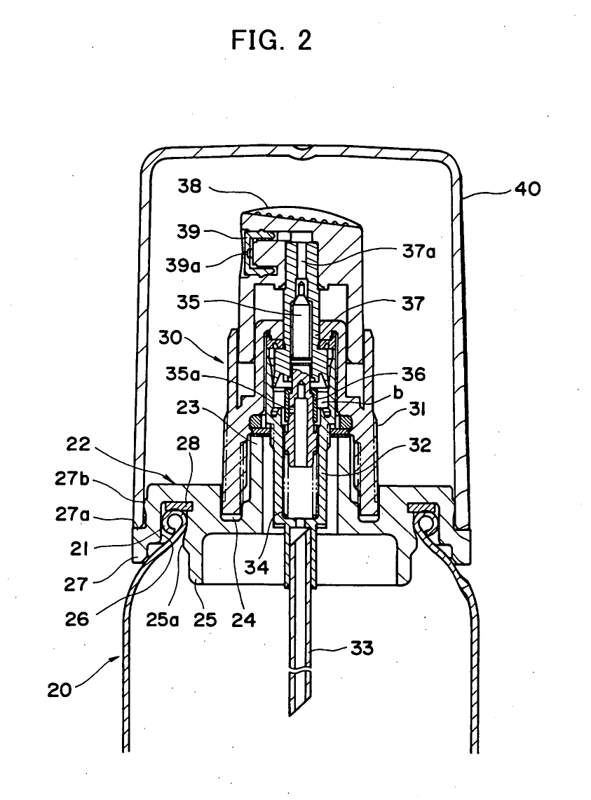

FIG. 1 is a side view illustrating the appearance of a reciprocating pump type spouting unit of the present invention which is in a state of not being used, and wherein a cap is illustrated in cross section, and FIG. 2 is a vertical sectional view thereof.

In the drawings, reference numeral 20 denotes a container. The container 20 may be made of a plastic material. In the illustrated embodiment, however, the container 20 is formed in the shape of a can by using a metal material such as aluminum or a tin plate. The mouth edge of the mouth of the container 20 is folded outward and is curled in a round shape to form a curl portion 21. A plastic adaptor 22 is fitted at its peripheral edge to the curl portion 21 so as to be mounted on the mouth of the container 20.

The adaptor 22 has a cylindrical portion 23 that is erected at the central portion thereof, the cylindrical portion 23 being externally threaded on the outer periphery thereof. An upwardly directed circumferential groove 24 is formed surrounding the cylindrical portion 23. The circumferential groove 24 is surrounded by a downwardly directed large-diameter cylindrical portion 25 having an outwardly directed protuberance 25a on the outer circumference thereof. A downwardly directed annular groove 26 is formed surrounding the large-diameter cylindrical portion 25. The annular groove 26 is surrounded by a flange portion 27 having an upwardly directed step portion 27a along the outer circumference thereof and an outwardly directed engaging portion 27b.

After a packing 28 is introduced into the annular groove 26, the curl portion 21 is introduced into the annular groove 26 beyond the outwardly directed protuberance 25a, such that the adaptor 22 is fitted to the mouth of the container 20.

A threaded cap 31 is fitted onto the cylindrical portion 23 of the adaptor 22, the internal thread in the inner periphery of the threaded cap 31 is screwed onto the external thread, and the lower part of the threaded cap 31 is introduced into the circumferential groove 24 thereby to mount a reciprocating pump 30. Thus, the reciprocating pump 30 is screwed onto the adaptor 22 and is mounted on the mouth of the container 20.

The threaded cap 31 has knurled grooves 31a formed in the outer periphery thereof and contains a cylinder 32 therein. The proximal end of a suction tube 33 is forcibly inserted in the lower end of the cylinder 32, and the distal end of the suction tube 33 is extending up to near the bottom of the container 20. A spring 34 is introduced into the cylinder 32 and, then, a piston 35 that also serves as an outlet valve is contained therein so as to move up and down. A communication hole 35a is perforated in the piston 35 to communicate the interior with the exterior, and an inlet valve 36 is attached to open and close the communication hole 35a. The inlet valve 36 is made of an elastic material.

The upper part of the piston 35 is inserted in the tubular stem 37 from the lower side thereof. The stem 37 is contained at its lower portion in the cylinder 32, and a pressure chamber b is formed being sectionalized by the cylinder 32, piston 35 and stem 37. The stem 37 has a spout passage 37a formed in the central portion thereof, and has a spout button 38 attached to the upper end thereof. A nozzle member 39 having a spout port 39a is attached to the spout button 38, and the spout port 39a is communicated with the spout passage 37a.

A cap 40 is placed to cover the reciprocating pump 30, and the lower edge thereof is placed on the upwardly directed step portion 27a so as to be engaged with the outwardly directed engaging portion 27b. The cap 40 is thus mounted on the adaptor 22.

To use the spout unit, the cap 40 is removed, the spout port 39a is directed to a desired portion and the spout button 38 is depressed. Therefore, the stem 37 is pushed in, the piston 35 in the reciprocating pump 30 moves together therewith against the spring 34 to increase the pressure in the pressure chamber b in a state where the inlet valve 36 is closed, and the piston 35 which is the outlet valve of the pressure chamber b is pushed down relative to the stem 37, whereby the content in the pressure chamber b is introduced into the spout passage 37a, and is blown out to the exterior from the spout port 39a through the stem 37. Thus, the content in the container is blown out to the desired portion.

When the operator removes the hand from the spout button 38, canceling the depressing of it, the spring 34 urges the piston 35, stem 37 and spout button 38 to return to their initial positions. Then, canceling the pushing-in of the the piston 35 to lower the pressure in the pressure chamber b, the inlet valve 36 is opened overcoming its own resiliency, and the content in the container 20 is sucked up into the cylinder 32 through the suction tube 33 and is introduced into the pressure chamber b through the communication hole 35a.

In the embodiment described above, the reciprocating pump 30 was mounted on the adaptor 22 by being screwed thereon. Not being limited to the screwing, however, the reciprocating pump 30 may be mounted by a so-called plugging such as fitting. The peripheral edge of the adaptor 22 was mounted on the mouth of the container 20 by being fitted thereto. Not being limited to the fitting, however, the adaptor may be mounted by wrap-fitting or by any other method.

### Industrial Applicability

The present invention can be applied to the reciprocating pump type spout units in which a reciprocating pump is operated by hand to once suck up the content in the container into the pressure chamber in the reciprocating pump and, then, to blow it out to the exterior in such applications as makeup, disinfection, washing, administering the drugs, painting and the like.

1. A reciprocating pump type spout unit in which a reciprocating pump is mounted on the mouth of a container, a piston of the reciprocating pump is pushed in to increase the pressure in a pressure chamber to blow out the content in the pressure chamber, and canceling the pushing-in of the piston to lower the pressure in the pressure chamber, and an inlet valve is opened so that the content in the container is sucked up into the pressure chamber, wherein the reciprocating pump is mounted on an adaptor, and the peripheral edge of the adaptor is mounted on the mouth of the container by being fitted thereto.

2. A reciprocating pump type spout unit according to claim 1, wherein the reciprocating pump is mounted on the adaptor by being screwed thereon.

3. A reciprocating pump type spout unit according to claim 1, wherein the container is made of a metal.

4. A reciprocating pump type spout unit according to claim 1, wherein a spout button is depressed to move a stem, the piston is pushed in to blow out the content in the pressure chamber from the spout port of the spout button through the stem and the stem is returned back when the depressing of the spout button is canceled, and canceling the pushing-in of the piston so that the content in the container is sucked up into the pressure chamber.

5. A reciprocating pump type spout unit according to claim 2, wherein the container is made of a metal.

6. A reciprocating pump type spout unit according to claim 2, wherein a spout button is depressed to move a stem, the piston is pushed in to blow out the content in the pressure chamber from the spout port of the spout button through the stem and the stem is returned back when the depressing of the spout button is canceled, and canceling the pushing-in of the piston so that the content in the container is sucked up into the pressure chamber.

7. A reciprocating pump type spout unit according to claim 3, wherein a spout button is depressed to move a stem, the piston is pushed in to blow out the content in the pressure chamber from the spout port of the spout button through the stem and the stem is returned back when the depressing of the spout button is canceled, and canceling the pushing-in of the piston so that the content in the container is sucked up into the pressure chamber.
